(19) United States
(12) Patent Application Publication
(10) Pub. No.: US 2011/0168867 A1
(43) Pub. Date: Jul. 14, 2011

(54) MICROPHONE SUPPORT SYSTEM

(76) Inventor: James R. Hennessey, West Hartford, CT (US)

(21) Appl. No.: 13/004,182

(22) Filed: Jan. 11, 2011

Related U.S. Application Data
(60) Provisional application No. 61/294,613, filed on Jan. 13, 2010.

(51) Int. Cl. F16F 7/00; F16B 2/20; F16M 11/02

(52) U.S. Cl. 248/636

(57) ABSTRACT

A system for supporting a microphone comprises a microphone clip having a holder, a shock absorber coupled to the holder, and a mount plate coupled to the shock absorber. The shock absorber comprises one or more webs having one or more openings defined therein, and the mount plate defines a pair of generally opposed channels. The clip is attachable to a grip plate mounted on a stand. The grip plate defines a pair of lips, each being configured to engage each of the generally opposed channels on the mount plate. A microphone support device comprises a microphone sleeve, a shock absorber integrally formed with the microphone sleeve, and a mount plate integrally formed with the shock absorber. The shock absorber comprises one or more webs having a plurality of openings. A grip plate is selectively engageable with the mount plate and is adjustably mountable on a microphone stand.

### CROSS REFERENCE TO RELATED APPLICATION

This application claims the benefit of U.S. provisional application No. 61/294,613, filed Jan. 13, 2010, the contents of which are incorporated herein by reference in their entirety.

### TECHNICAL FIELD

The present invention is directed in general to microphone support equipment and, more particularly, to a system for supporting a microphone, the system having the ability to absorb vibration in an effort to avoid undesirable noise generated by shock to the microphone.

### BACKGROUND

Conventional microphone support equipment generally comprises a mounting device supported on an upright member that is in turn supported on a legged or weighted base. A sleeve is connected to the mounting device, the sleeve being configured to receive a microphone therein. The mounting device may be movable relative to the upright member (e.g., it can be swiveled) to allow the microphone to be rotated around the upright member. The sleeve is generally connected to the mounting device using a screw/wing nut assembly or the like, the tightening and loosening of which allows the sleeve (and thus the microphone) to be angled and set to a position desired by a user.

Because the connection of the sleeve to the mounting device is typically a rigid connection, movement of the base or any sudden shock (intentional or otherwise) to the base or upright member can cause undesirable vibration that can be transferred through the mounting device and the sleeve to the microphone. Such undesirable vibrations, when transferred to the microphone, can be picked up by the microphone and inadvertently broadcast over a public address system to which the microphone is connected.

### SUMMARY

In one aspect, the present invention resides in a system for supporting a microphone. Such a system comprises a microphone clip having a holder, a shock absorber coupled to the holder, and a mount plate coupled to the shock absorber. The shock absorber comprises one or more webs having one or more openings defined therein, and the mount plate defines a pair of generally opposed channels. The clip is attachable to a grip plate mounted on a stand. The grip plate defines a pair of lips, each of the lips being configured to engage each of the generally opposed channels on the mount plate.

In another aspect, the present invention resides in a microphone support device comprising a microphone sleeve, a shock absorber integrally formed with the microphone sleeve, and a mount plate integrally formed with the shock absorber. The shock absorber comprises one or more webs having a plurality of openings. A grip plate is selectively engageable with the mount plate and is adjustably mountable on a microphone stand.

In another aspect, the present invention resides in a microphone clip comprising a microphone sleeve, a shock absorber comprising one or more webs defining a plurality of openings coupled to the microphone sleeve, and a plate to which the shock absorber is coupled. The plate is attachable to an adjustably positionable head on a microphone stand.

### BRIEF DESCRIPTION OF THE DRAWINGS

FIG. 1 is an exploded perspective view of a system for supporting a microphone in accordance with the present invention.

FIG. 2 is a perspective view of a holder, shock absorber, and mount plate of a microphone clip of the present invention.

FIG. 3 is a top view of the holder, shock absorber, and mount plate of the microphone clip of FIG. 2.

FIG. 4 is a side view of the holder, shock absorber, and mount plate of the microphone clip of FIG. 2.

FIG. 5 is a front view of the holder, shock absorber, and mount plate of the microphone clip of FIG. 2.

FIG. 6 is a back view of the holder, shock absorber, and mount plate of the microphone clip of FIG. 2.

FIG. 7 is a front view of the mount plate of the microphone clip of the present invention.

FIG. 8 is a side view of one member of a grip plate of the microphone clip of the present invention.

FIG. 9 is an exploded perspective view of an alternate embodiment of a grip plate of the microphone clip of the present invention.

### DETAILED DESCRIPTION

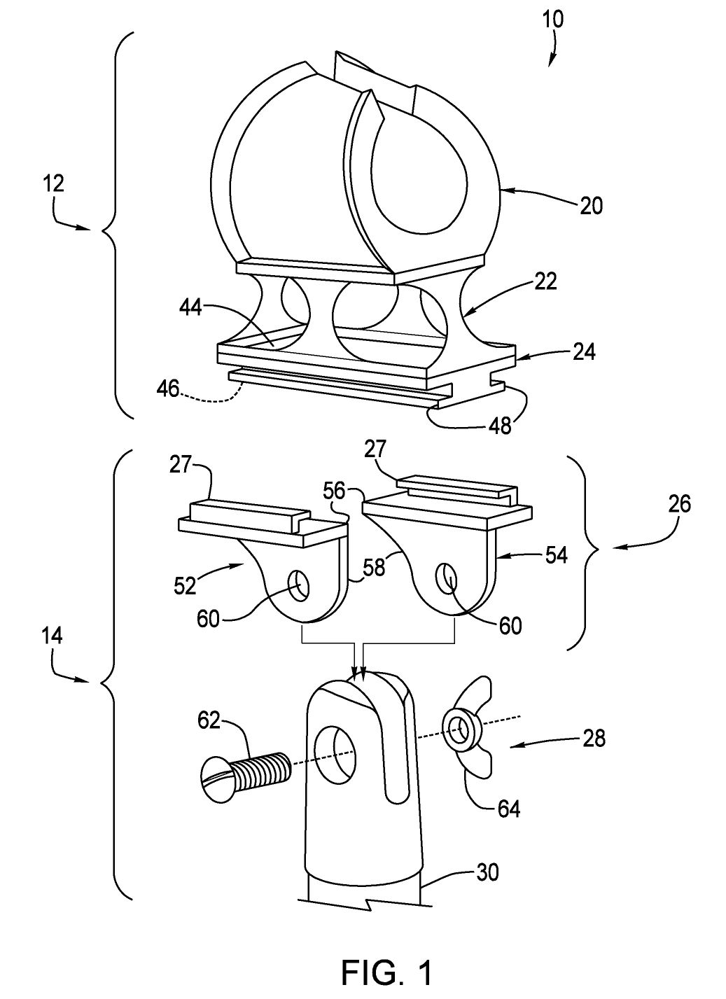

As shown in FIG. 1, a system for supporting a microphone in accordance with the present invention is designated generally by the reference number 10 and is hereinafter referred to as “system 10.” System 10 comprises a microphone clip 12 adjustably mounted on a stand 14. The microphone clip 12 comprises a holder 20 or sleeve in which a microphone can be received, a shock absorber 22 coupled to the holder, and a mount plate 24 coupled to the shock absorber. The present invention is not limited to the holder 20 being coupled to the shock absorber 22 and/or the shock absorber being coupled to the mount plate 24, however, as one or more of the holder, the shock absorber, and the mount plate may be integrally formed with the other. Preferably, the holder 20, the shock absorber 22, and the mount plate 24 are integrally formed as one piece. The mount plate 24 is configured to be mounted on a grip plate 26, the grip plate having lips 27 for receiving the mount plate. The grip plate 26 is removably attached to and adjustably positionable on a slotted head 28 located on an upright member 30 of the stand 14.

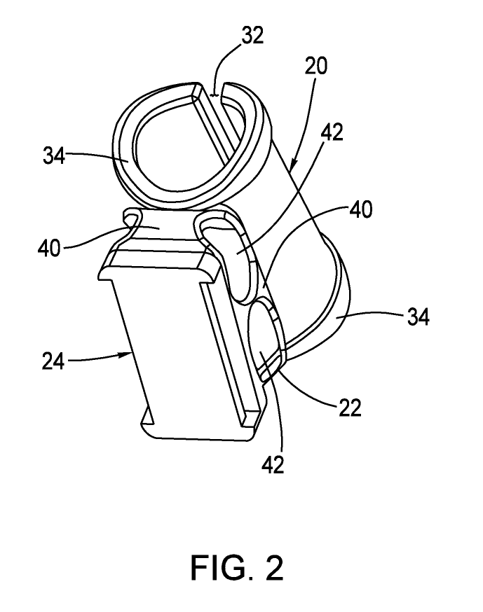

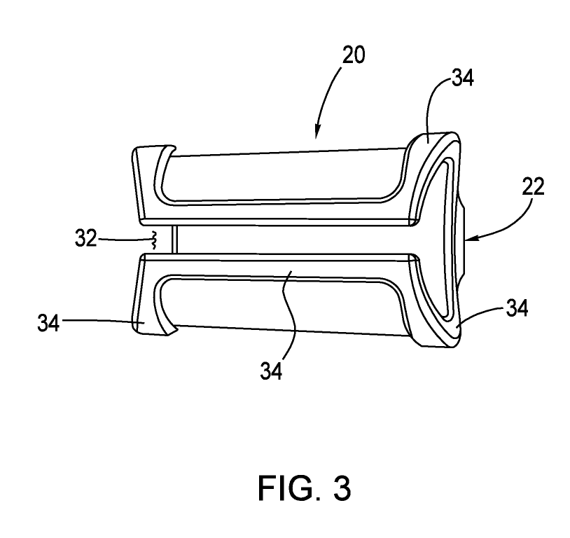

As shown in FIGS. 2 and 3, the holder 20 is substantially cylindrical or frusto-conical in shape. The holder 20 is formed from a resilient material and defines a bore extending therethrough to accept a body portion of the microphone. An elongated opening 32 extends longitudinally from one end of the holder to the other. The elongated opening 32 allows the holder 20 to flex and expand to grippingly engage a microphone mounted therein. Defining edges of the holder 20, namely, the edges defining the elongated opening 32 and the opposing ends of the substantially cylindrical or frusto-conically-shaped structure of the holder, may include reinforcing structure 34 that is thicker than the resilient material forming the general body of the holder in order to provide the microphone clip 12 with the ability to withstand aggressive use.

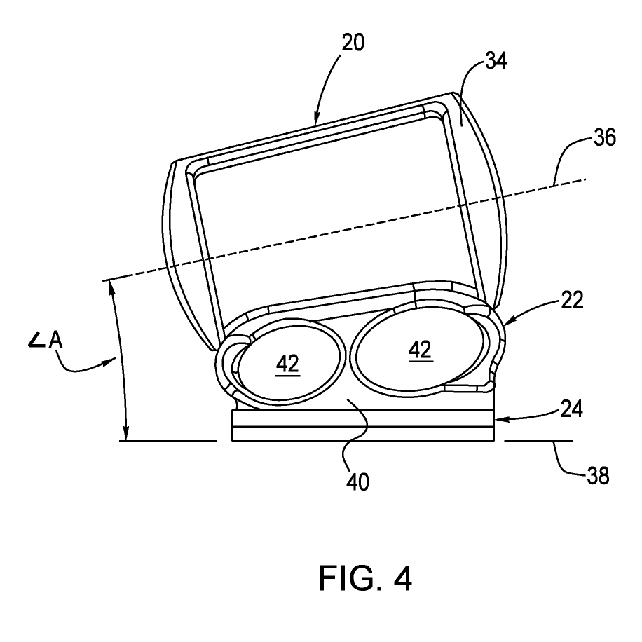

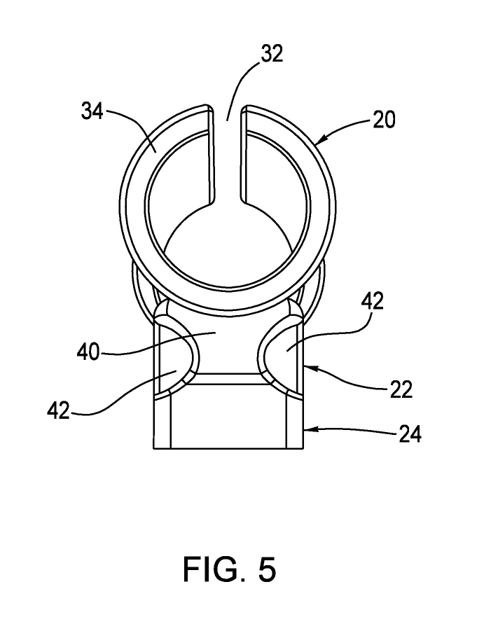

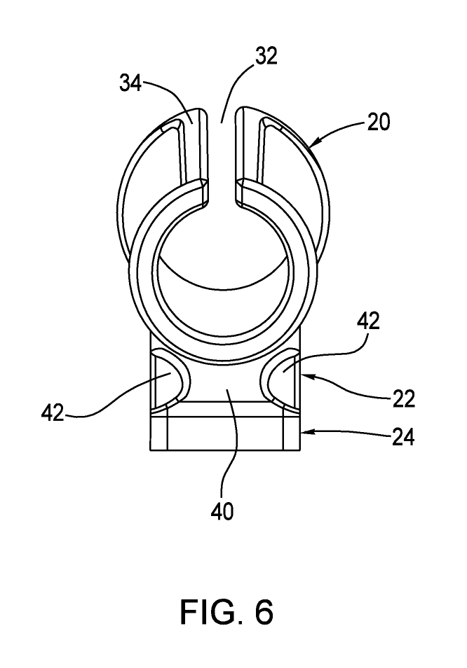

As shown in FIGS. 4-6, the holder 20 is angled relative to the mount plate 24. Referring to FIG. 4 in particular, an axis 36 extending longitudinally through the holder 20 forms an angle A with a plane 38 coincident with a lower surface of the mount plate 24. The angle A may be about 15 degrees, as shown. The present invention is not so limited, however, as the angle A may be any suitable angle, for example, about 5 degrees to about 45 degrees. Configuring the holder 20 to have an angle A between the axis 36 and the plane 38 allows the grip plate 26 to be mounted on the slotted head 28 in a substantially horizontal configuration, thereby facilitating retention of the grip plate in the slotted head, while enabling the microphone to be positioned at an angle.

Also as shown in FIGS. 2 and 4-6, the shock absorber 22 comprises a plurality of webs 40 that depend from the holder 20 and are formed with or attach, connect, or are otherwise coupled to the mount plate 24. The webs 40 are connected to each other and to the holder 20 and are sufficiently stiff to allow the holder to be supported while accommodating a microphone. The present invention is not limited to a plurality of connected webs 40, however, as the shock absorber 22 may comprise one continuous web 40. In any configuration, however, the web(s) 40 defines openings 42 that allow the shock absorber 22 to flex to absorb the impacts of jarring motion. As shown, the openings 42 are located longitudinally along the sides of the shock absorber 22 and partially at the front and back thereof. The holder 20 and the shock absorber 22 are made from suitable materials such as, but not limited to, elastomers, elastomeric polymers, polymers, and combinations thereof.

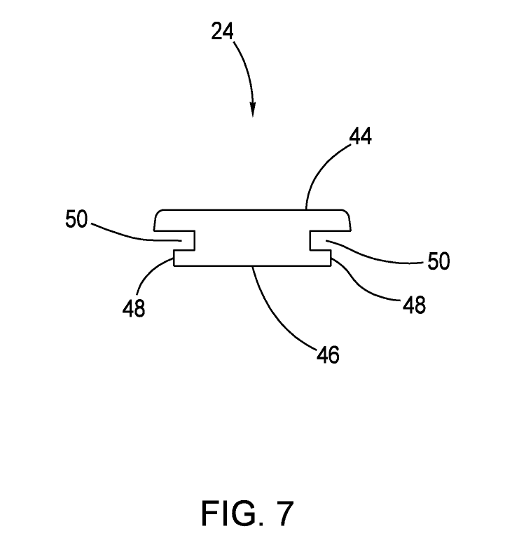

As shown in FIGS. 1 and 7, the mount plate 24 comprises a substantially flat member having an upper surface 44 on which the webs 40 are located and a lower surface 46 opposite the upper surface. A width of the lower surface 46 is less than a width of the upper surface 44 so as to define mounting tabs 48 that extend longitudinally along the sides of the lower surface, thereby defining channels 50. In connecting the mount plate 24 to the grip plate 26 (FIG. 1), the mount plate 24 is slidingly engaged with the grip plate such that the mounting tabs 48 are received underneath the lips 27 on the grip plate. The mounting tabs 48 may be retained in place under the lips 27 via a frictional fit. The lower surface 46 and the mounting tabs 48 define a T-shaped cross-section with regard to the mount plate 24. However, while a T-shaped cross-section has been shown and described, the present invention is not limited in this regard as other cross-sectional shapes can also be employed without departing from the broader aspects of the present invention.

The mount plate 24 is also preferably made from a suitable material such as, but not limited to, elastomers, elastomeric polymers, polymers, and combinations thereof. However, the present invention is not limited in this regard as the mount plate can also be formed from polymers and/or composite materials in general, as well as metals, without departing from the broader aspects of the present invention.

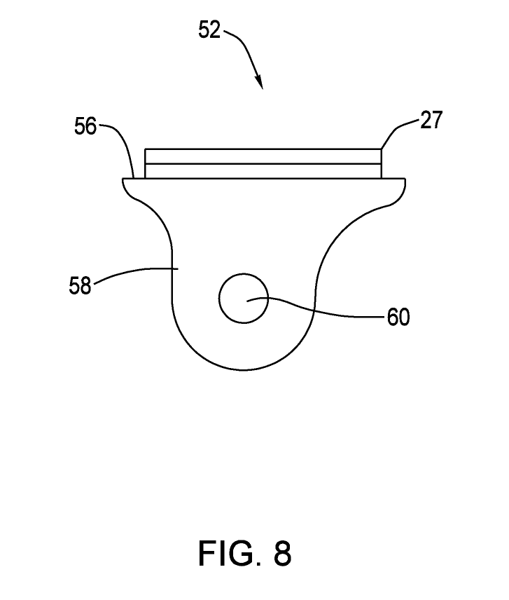

As shown in FIGS. 1 and 8, the grip plate 26 comprises a first member 52 and a second member 54, each being defined by a flat planar surface 56 and a tongue 58 depending from the underside thereof, each tongue 58 being configured to be received into the slot of the slotted head 28. Each tongue 58 also includes a hole 60 extending therethrough for receiving a fastener (such as a screw 62 and a wing nut 64 inserted through the slotted head 28 and the tongues 58, as shown in FIG. 1) that can be tightened to retain the first and second members in a cooperative relationship. The upper surface of each of flat planar surface 56 includes protruding structure that defines each of the lips 27.

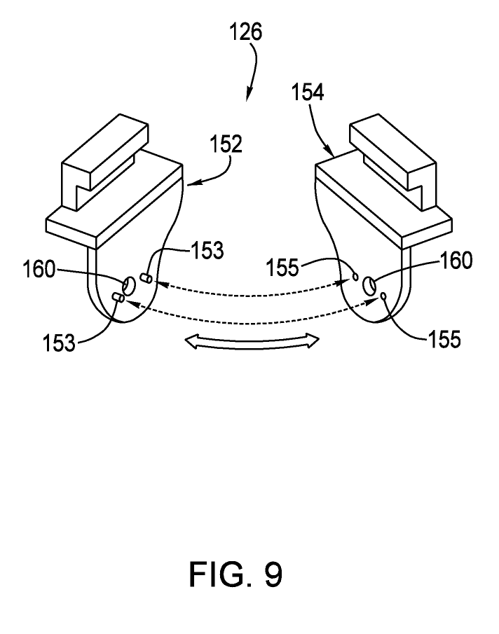

As an alternative to the grip plate 26 using only the fastener to retain the first member 52 and the second member 54 in a cooperative relationship on the slotted head 28, a grip plate 126 as shown in FIG. 9 includes a first member 152 having one or more pins 153 or the like protruding therefrom, the pins being configured to be engaged in corresponding hole(s) 155 in a cooperating second member 154. As shown, the pins 153 and the corresponding holes are located on the first member 152 and the second member 154 adjacent to and on opposing sides of the hole 160 through which the fastener 62 is received. In such a configuration, the engagement of the pins 153 in the holes allows the first member 152 and the second member 154 to be rotated on the slotted head 28 in unison when the mount plate 24 is not located on the grip plate 126.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A system for supporting a microphone, the system comprising:
a microphone clip, comprising,
a holder,
a shock absorber coupled to the holder, the shock absorber comprising one or more webs having one or more openings defined therein, and
a mount plate coupled to the shock absorber, the mount plate defining a pair of generally opposed channels;
a grip plate on which the mount plate is received, the grip plate defining a pair of lips, each of the lips being configured to engage each of the generally opposed channels; and
a stand on which the grip plate is mounted.

2. The system of claim 1, wherein the holder includes an elongated opening that extends longitudinally from one end of the holder to the other end of the holder.

3. The system of claim 1, wherein the shock absorber is fabricated from a material selected from the group of materials consisting of elastomers, elastomeric polymers, polymers, and combinations of the foregoing materials.

4. The system of claim 1, wherein the holder is angled relative to the mount plate.

5. The system of claim 1, wherein the mount plate is defined by an upper surface to which the one or more webs are coupled and a lower surface opposite the upper surface, and wherein a width of the lower surface is less than a width of the upper surface.

6. The system of claim 5, wherein the width of the lower surface relative to the width of the upper surface defines tabs that define the pair of generally opposed channels.

7. The system of claim 1, wherein the stand includes a slotted head on which the grip plate is removably and adjustably mounted.

8. A microphone support device, comprising:
a microphone sleeve;
a shock absorber integrally formed with the microphone sleeve, the shock absorber comprising one or more webs having a plurality of openings;
a mount plate integrally formed with the shock absorber; and
a grip plate selectively engageable on the mount plate;
wherein the grip plate is adjustably mountable on a microphone stand.

9. The microphone support device of claim 8, wherein the microphone sleeve defines an elongated opening that extends longitudinally from one end of the microphone sleeve to the other end of the microphone sleeve.

10. The microphone support device of claim 8, wherein the one or more webs of the shock absorber are fabricated from a material selected from the group of materials consisting of elastomers, elastomeric polymers, polymers, and combinations of the foregoing materials.

11. The microphone support device of claim 8, wherein the mount plate is defined by an upper surface with which the one or more webs are integrally formed and a lower surface opposite the upper surface, and wherein a width of the lower surface is less than a width of the upper surface so as to define tabs that form a pair of generally opposed channels longitudinally along sides of the mount plate for engaging the grip plate.

12. A microphone clip, comprising:
a microphone sleeve;
a shock absorber comprising one or more webs defining a plurality of openings coupled to the microphone sleeve; and
a plate to which the shock absorber is coupled;
wherein the plate is attachable to an adjustably positionable head on a microphone stand.

13. The microphone clip of claim 12, further comprising a grip plate for attaching the plate to the adjustably positionable head.

14. The microphone clip of claim 13, wherein the grip plate comprises a first member and a second member cooperatively engageable with each other.

15. The microphone clip of claim 14, wherein each of the first member and the second member includes a lip, each of the lips being engageable with the plate on which the shock absorber is mounted.

16. The microphone clip of claim 14, wherein the first member and the second member cooperatively engageable with each other are fastenable to each other using a fastener.

17. The microphone clip of claim 14, wherein the first member includes a pin and the second member includes a hole in which the pin is received.

18. The microphone clip of claim 12, wherein the shock absorber is fabricated from a material selected from the group of materials consisting of elastomers, elastomeric polymers, polymers, and combinations of the foregoing materials.
